(19) United States
(12) Patent Application Publication
(10) Pub. No.: US 2006/0111044 A1
(43) Pub. Date: May 25, 2006

(54) Stereo signal communication using bluetooth transceivers in earpieces

(76) Inventor: Mark A. Keller, Pomona, CA (US)

Correspondence Address: PHILIPS INTELLECTUAL PROPERTY & STANDARDS, P.O. BOX 3001, BRIARCLIFF MANOR, NY, 10510, US

(21) Appl. No.: 10/536,644

(22) PCT Filed: Nov. 26, 2003
(86) PCT No.: PCT/IB03/05492

§ 371 Date: May 27, 2005

Related U.S. Application Data
(60) Provisional application No. 60/430,916, filed on Dec. 4, 2002.

(51) Int. Cl. H04B 7/00; H04M 1/00

(52) U.S. Cl. 455/41.2; 455/575.2

(57) ABSTRACT

A system and method for signal communication. First and second audio signals are wirelessly transmitted a Bluetooth transceiver T over a first channel and a second channel to Bluetooth transceivers T1 and T2, respectively, in accordance with prevailing Bluetooth standards. The transceivers T1 and T2 are respectively comprised by first and second earpieces each fitted within or behind a first ear and a second ear of a person in a manner that is sufficient for the person to hear the first and second audio signals. The combination of the first and second audio signals constitutes a stereo signal. The first and second earpieces are not mechanically connected to each other by a headset or by any mechanical device that is adapted to fit on the head of the person.

The present invention relates generally to a system and method for signal communication and more particularly to a system and method for signal communication in which a person receives a stereo signal using earpieces not mechanically connected to each other. Radio frequency transmissions from a consumer electronics device to a portable receiving device (e.g., a headset) to receive such transmissions are impractical, since such transmissions consume high power which necessitates that a battery powering the portable receiving device would have to be changed too frequently. Thus there is a need for a low-power system and method of signal communication from a consumer electronics device to a portable receiving device.

The present invention provides a system for signal communication, comprising:

a first earpiece comprising a first Bluetooth transceiver T1, the transceiver Ti adapted to receive a first audio signal transmitted wirelessly from a Bluetooth transceiver T over a first channel, the first audio signal being transmitted by the transceiver T and received by the transceiver T1 in accordance with prevailing Bluetooth standards, the first earpiece adapted to fit within or behind a first ear of a person in a manner that is sufficient for the person to hear the first audio signal; and

second earpiece comprising a second Bluetooth transceiver T2, the transceiver 12 adapted to receive a second audio signal transmitted wirelessly from the transceiver T over a second channel, the second audio signal being transmitted by the transceiver T and received by the transceiver T2 in accordance with prevailing Bluetooth standards, the second earpiece adapted to fit within or behind a second ear of the person in a manner that is sufficient for the person to hear the second audio signal, the combination of the first audio signal and the second audio signal being a stereo signal, the first earpiece and the second earpiece not being mechanically connected to each other by a headset or by any mechanical device that is adapted to fit on the head of the person.

The present invention provides a method for signal communication, comprising: wirelessly receiving, by a first Bluetooth transceiver T1, a first audio signal transmitted by a Bluetooth transceiver T over a first channel, the first audio signal being transmitted by the transceiver T and received by the transceiver T1 in accordance with prevailing Bluetooth standards, the transceiver T being comprised by a first earpiece fitted within or behind a first ear of a person in a manner that is sufficient for the person to hear the first audio signal; and

wirelessly receiving, by a second Bluetooth transceiver T2, a second audio signal transmitted by the transceiver T over a second channel, the second audio signal being transmitted by the transceiver T and received by the transceiver T2 in accordance with prevailing Bluetooth standards, the Bluetooth transceiver T being comprised by a second earpiece fitted within or behind a second ear of the person in a manner that is sufficient for the person to hear the second audio signal, the combination of the first audio signal and the second audio signal being a stereo signal, the first earpiece and the second earpiece not being mechanically connected to each other by a headset or by any mechanical device that is adapted to fit on the head of the person.

The present invention advantageously provides a low-power system and method of signal communication from a consumer electronics device to a portable receiving device, namely to left and right earpieces which are adapted to fit within or behind the ears of person. The earpieces have the advantage of not being mechanically connected to each other.

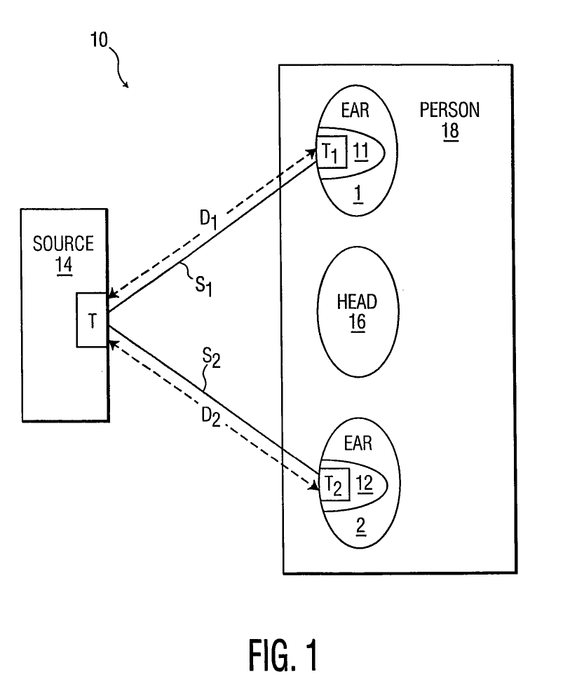

FIG. 1 depicts a signal communication system for stereo signal communication between a Bluetooth transceiver (T) inside a signal source device and first and second Bluetooth transceivers (T1 and T2) within or behind the first and second ears of a person, respectively, in accordance with embodiments of the present invention.

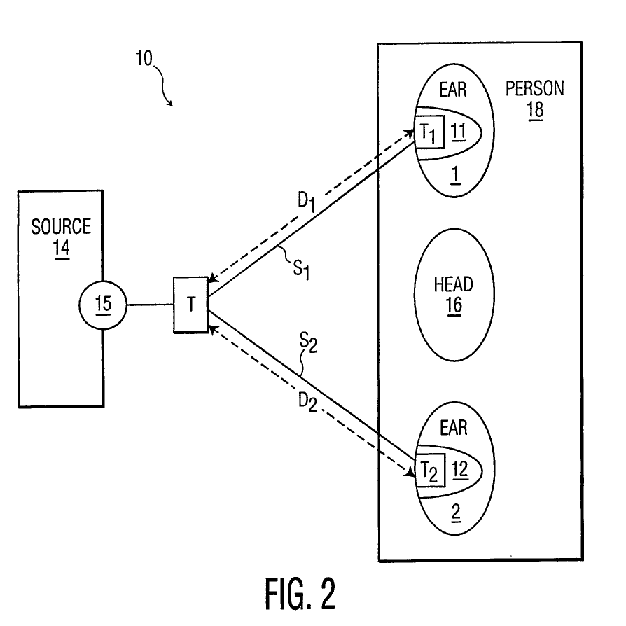

FIG. 2 depicts the signal communication system of FIG. 1 with the Bluetooth transceiver T being located external to the signal source device and electrically coupled to the signal source device, in accordance with embodiments of the present invention.

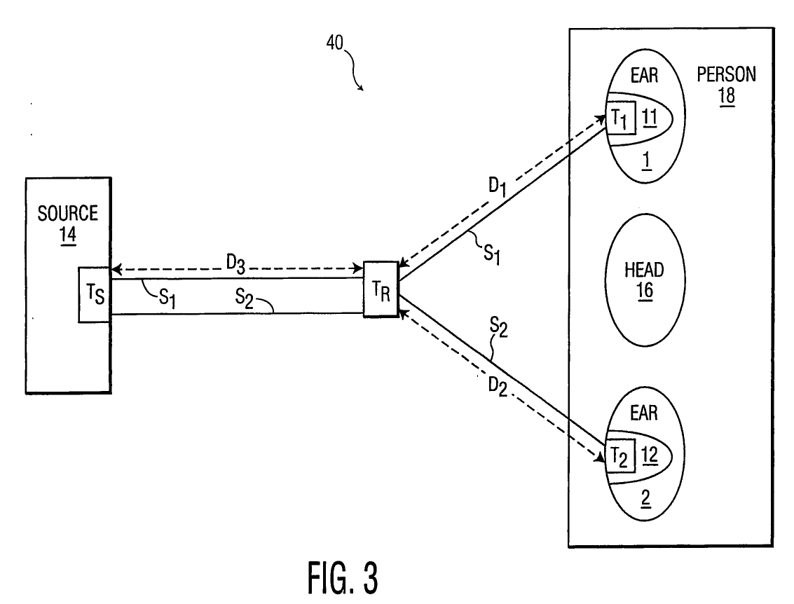

FIG. 3 depicts a signal communication system for stereo signal communication between a Bluetooth transceiver (TS) inside a signal source device and first and second Bluetooth transceivers (T1 and T2) within or behind the first and second ears of a person, respectively, with a repeater Bluetooth transceiver (TR) interfacing between the transceiver TS and the transceivers T1 and T2, in accordance with embodiments of the present invention.

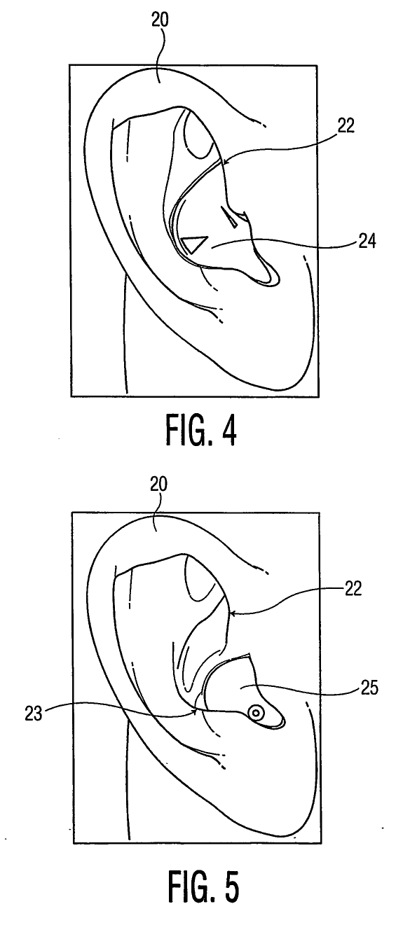

FIG. 4 depicts an earpiece fitted within the concha bowl of an ear of a person, in accordance with embodiments of the present invention.

FIG. 5 depicts an earpiece fitted in the canal, but not wholly within the concha bowl, of an ear of a person, such that the earpiece is primary visible to an ordinary observer of the ear, in accordance with embodiments of the present invention.

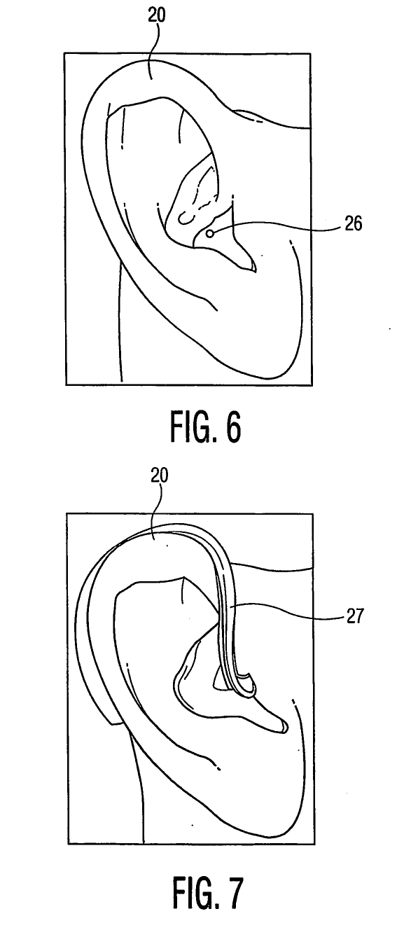

FIG. 6 depicts an earpiece fitted in the canal of an ear of a person, such that the earpiece is primarily not visible to an ordinary observer of the ear, in accordance with embodiments of the present invention.

FIG. 7 depicts an earpiece fitted behind the ear of a person, in accordance with embodiments of the present invention.

Bluetooth is a standard developed by a group of electronics manufacturers that allows various electronic devices, such as inter alia consumer electronic devices (e.g., a compact disc (CD) player, a cassette tape player, a Moving Picture Experts Group Audio Layer 3 (MP3) player, a telephone cell phone, a computer, etc.) to wirelessly connect with other electronic devices in accordance with a prescribed communication protocol. Each Bluetooth communicating device has a small transceiver (i.e., transmitter and receiver) built into the communicating device at an allowable radio frequency. The signal communication systems disclosed in the present invention comprise Bluetooth transceivers, namely transceivers which wirelessly communicate with each other in accordance with prevailing Bluetooth standards. Since the prevailing Bluetooth standards are may vary over time as wireless technology advances, the prevailing Bluetooth standards are dynamic rather than static standards. The prevailing Bluetooth standards are agreed-upon standard which have international scope. As this patent disclosure is being drafted, the prevailing Bluetooth standards may be found in the following website: http://www.bluetooth.org/specifications.htm.FIG. 1 depicts a signal communication system 10 for stereo signal communication between a Bluetooth transceiver (T) and a person 18, in accordance with embodiments of the present invention. The transceiver T is electrically coupled to signal source device 14 and disposed within the source device 14. The source device 14 is adapted to generate a first audio signal S1 and a second audio signal S2. The transceiver T may be comprised by a semiconductor chip internally disposed within the source device 14.

The first audio signal S1 and the second audio signal S2 constitute, in combination, a stereo signal. For example, the first audio signal S1 and the second audio signal S2 may be a first stereo component and a second stereo component, respectively, of a musical signal. The transceiver T wirelessly transmits the first audio signal S1 over a first channel to a first Bluetooth transceiver (T1). The transceiver T wirelessly transmits the second audio signal S2 over a second channel to a second Bluetooth transceiver (T2). The first audio signal S1 and the second audio signal S2 are transmitted by the transceiver T and received by the transceivers T1 and T2, respectively, in accordance with prevailing Bluetooth standards. The transceiver T transmits the first audio signal S1 and the second audio signal S2 each at low power such as, inter alia, at a power not exceeding about 1 milliwatt. The low power conserves battery life for batteries that power the transceivers T1, and T2 (and also transceiver T if transceiver T is battery powered). Due to said low power, first audio signal S1 and the second audio signal S2 each have a limited range such as, inter alia, 10 meters from the transceiver T. Thus, the distance D1 between the transceiver T and the transceiver T1 may be limited to about 10 meters or less, and the distance D2 between the transceiver T and the transceiver T2 may be limited to about 10 meters or less.

The source device 14 may be any device capable of generating the first audio signal S1 and the second audio signal S2 such as consumer electronics device which may comprise, inter alia, a compact disc (CD) player, a cassette tape player, or a Moving Picture Experts Group Audio Layer 3 (MP3) player.

The transceiver T1 is disposed in an earpiece 11. The earpiece 11 is positioned within or behind a first ear 1 of the person 18 in a manner that is sufficient for the person 18 to hear the first audio signal S1. The transceiver T2 is disposed in an earpiece 12. The earpiece 12 is positioned within or behind a second ear 2 of the person 18 in a manner that is sufficient for the person 18 to hear the second audio signal S2. The first ear 1 of the person 18 is either the left ear or the right ear of the person 18. If the first ear 1 is the left ear of the person 18, then the second ear 2 is the right ear of the person 18. If the first ear 1 is the right ear of the person 18, then the second ear 2 is the left ear of the person 18. The earpiece 11 and the earpiece 12 are not mechanically connected to each other by a headset or by any mechanical device that is adapted to fit on the head 16 of the person or by any mechanical device generally. Various ways of positioning the earpiece 11 and the earpiece 12 within or behind the ear 1 and the ear 2, respectively, in FIG. 1 is described infra in conjunction with FIGS. 4-7. In addition, the earpiece 1 l and the earpiece 12 are each not adapted to facilitate transmission of voice vibrations of the person 18 to the transceiver T.

FIG. 2 depicts the signal communication system 10 of FIG. 1 for stereo signal communication between the Bluetooth transceiver (T) and the person 18, with the Bluetooth transceiver T being located external to the signal source device 14 and electrically coupled to the signal source device 14 by wiring such as, inter alia, through a line output channel 15 of the source device 14, in accordance with embodiments of the present invention. In all other respects, the structure, functionality, and features described supra in conjunction with FIG. 1 apply to FIG. 2.

Generally, the transceiver T may be electrically coupled to the source device 14 either wirelessly or by wiring. If the transceiver T is electrically coupled to the source device 14 wirelessly, then the source device 14 would comprise a Bluetooth transceiver to effectuate said wireless electrical coupling between the source device 14 and the transceiver T. As example of such wireless electrical coupling is depicted in FIG. 3 in which the transceiver T is replaced by a transceiver TR as will be described infra.

FIG. 3 depicts a signal communication system 40 for stereo signal communication between a Bluetooth transceiver (TS) and the person 18, in accordance with embodiments of the present invention. The transceiver TS is disposed within the signal source device 14 that is adapted to generate a first audio signal S1 and a second audio signal S2. The transceiver TS may be electrically coupled to the signal source device 14 by wiring. For example, the transceiver TS may be comprised by a semiconductor chip internally disposed within the source device 14 as shown Alternatively, the transceiver TS may be located external to the signal source device 14 and electrically coupled to the signal source device 14 through a line output channel of the source device 14 such as the line output channel 15 that electrically couples the transceiver T to the source device 14 in FIG. 2.

In FIG. 3, the first audio signal S1 and the second audio signal S2 constitute, in combination, a stereo signal. For example, the first audio signal S1 and the second audio signal S2 may be a first stereo component and a second stereo component, respectively, of a musical signal. The transceiver T wirelessly transmits the first audio signal S1 over a channel C1 to a Bluetooth repeater transceiver (TR), and the transceiver TR wirelessly transmits the first audio signal S1 over a channel C2 to a first Bluetooth transceiver (T1).

The channels C1 and C2 may be the same channel or different channels. The transceiver T wirelessly transmits the second audio signal S2 over a channel C3 to the transceiver TR and the transceiver TR wirelessly transmits the second audio signal S2 over a channel C4 to a second Bluetooth transceiver (T2). The channels C3 and C4 may be the same channel or different channels.

The first audio signal S1 and the second audio signal S2 are transmitted by the transceiver TS to the transceiver TR, and then by the transceiver TR to the transceivers T1 and 12, respectively, in accordance with prevailing Bluetooth standards. The transceivers TS and each transmit the first audio signal S1 and the second audio signal S2 each at low power such as, inter alia, at a power not exceeding about 1 milliwatt. The low power conserves battery life for batteries that power the transceivers TR, T1, and T2 (and also transceiver TS if transceiver TS is battery powered). Due to said low power, the first audio signal S1 and the second audio signal S2 each have a limited range such as, inter alia, 10 meters from the transceiver TS and to the transceiver TR, and from the transceiver TR to each of the transceivers T1 and T2. Thus, the distance D3 between the transceiver TS and the transceiver TR may be limited to about 10 meters or less. Similarly, the distance D1 between the transceiver TR and the transceiver T1 may be limited to about 10 meters or less, and the distance D2 between the transceiver TR and the transceiver T2 may be limited to about 10 meters or less.

The source device 14 may be any device capable of generating the first audio signal S1 and the second audio signal S2 such as consumer electronics device which may comprise, inter alia, a compact disc(CD) player, a cassette tape player, or a Moving Picture Experts Group Audio Layer 3 (MP3) player.

The transceiver T1 is disposed in an earpiece 11. The earpiece T1 is positioned within or behind a first ear 1 of the person 18 in a manner that is sufficient for the person 18 to hear the first audio signal S1. The transceiver T2 is disposed in an earpiece 12. The earpiece 12 is positioned within or behind a second ear 2 of the person 18 in a manner that is sufficient for the person 18 to hear the second audio signal S2. The first ear 1 of the person 18 is either the left ear or the right ear of the person 18. If the first ear 1 is the left ear of the person 18, then the second ear 2 is the right ear of the person 18. If the first ear 1 is the right ear of the person 18, then the second ear 2 is the left ear of the person 18. The earpiece 11 and the earpiece 12 are not mechanically connected to each other by a headset or by any mechanical device that is adapted to fit on the head 16 of the person or by any mechanical device generally. Various ways of positioning the earpiece 11 and the earpiece 12 within or behind the ear 1 and the ear 2, respectively, in FIG. 3 is described infra in conjunction with FIGS. 4-7. In addition, the earpiece 11 and the earpiece 12 are each not adapted to facilitate transmission of voice virations of the person 18 to the transceiver TR.

FIGS. 4-8 depict various ways of positioning an earpiece within or behind an ear, as applied to positioning the earpiece 11 and the earpiece 12 within or behind the ear 1 and the ear 2, respectively, in FIGS. 1-3. In FIGS. 4-7, an ear 20 represents the ear 1 or the ear 2 of FIGS. 1-3, and the earpieces 24-28 each represent the earpiece 11 or the earpiece 12 of FIGS. 1-3.

FIG. 4 depicts an earpiece 24 fitted within the concha bowl 22 of the ear 20 of the person 18 of FIGS. 1-3, in accordance with embodiments of the present invention.

FIG. 5 depicts an earpiece 25 fitted in the canal 23, but not wholly within the concha bowl 22, of the ear 20 of the person 18 of FIGS. 1-3, such that the earpiece 25 is primarily visible to an ordinary observer of the ear 20, in accordance with embodiments of the present invention. The earpiece 25 is defined to be “primarily visible” to an ordinary observer if more than 50% of the largest surface of the earpiece 25 is visible to the ordinary observer while the earpiece 25 is so positioned within the canal 23.

FIG. 6 depicts an earpiece 26 fitted in the canal 23 of the ear 20 of the person 18 of FIGS. 1-3, such that the earpiece 26 is primarily not visible to an ordinary observer of the ear 20, in accordance with embodiments of the present invention. The earpiece 26 is defined to be “primarily not visible” to an ordinary observer if no more than 50% of the largest surface of the earpiece 26 is visible to the ordinary observer while the earpiece 26 is so positioned within the canal 23.

FIG. 7 depicts an earpiece 27 fitted behind the ear 20 of the person 18 of FIGS. 1-3, in accordance with embodiments of the present invention. While embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A system for signal communication, comprising:
a first earpiece comprising a first Bluetooth transceiver T1, the transceiver T1 adapted to receive a first audio signal transmitted wirelessly from a Bluetooth transceiver T over a first channel, the first audio signal being transmitted by the transceiver T and received by the transceiver T1 in accordance with prevailing Bluetooth standards, the first earpiece adapted to fit within or behind a first ear of a person in a manner that is sufficient for the person to hear the first audio signal; and
a second earpiece comprising a second Bluetooth transceiver 12, the transceiver T2 adapted to receive a second audio signal transmitted wirelessly from the transceiver T over a second channel, the second audio signal being transmitted by the transceiver T and received by the transceiver T2 in accordance with prevailing Bluetooth standards, the second earpiece adapted to fit within or behind a second ear of the person in a manner that is sufficient for the person to hear the second audio signal, the combination of the first audio signal and the second audio signal being a stereo signal, the first earpiece and the second earpiece not being mechanically connected to each other by a headset or by any mechanical device that is adapted to fit on the head of the person.

2. The system of claim 1, wherein the first earpiece and the second earpiece are not mechanically connected to each other by any mechanical device.

3. The system of claim 1, wherein the first earpiece and the second earpiece are each adapted to fit within the concha bowl of the first ear and the second ear, respectively.

4. The system of claim 1, wherein the first earpiece and the second earpiece are each adapted to fit in the canal, but not wholly within the concha bowl, of the first ear and the second ear, respectively, such that the first and second earpieces are primarily visible to an ordinary observer of the first ear and the second ear.

5. The system of claim 1, wherein the first earpiece and the second earpiece are each adapted to essentially fit in the canal of the first ear and the second ear, respectively, such that the first and second earpieces are primarily not visible to an ordinary observer of the first ear and the second ear.

6. The system of claim 1, wherein the first earpiece and the second earpiece are each adapted to fit behind the first ear and the second ear, respectively.

7. The system of claim 1, wherein the first and second earpieces are not adapted to facilitate transmission of voice vibrations of the person to the transceiver T.

8. The system of claim 1, wherein the first audio signal and the second audio signal are a first stereo component and a second stereo component, respectively, of a musical signal.

9. The system of claim 1, wherein the first audio signal is adapted to be transmitted by the transceiver T to the transceiver T1 at a power not exceeding about 1 milliwatt, and wherein the second audio signal is adapted to be transmitted by the transceiver T to the transceiver T2 at a power not exceeding about 1 milliwatt

10. The system of claim 1, wherein a range of the first audio signal as transmitted by the transceiver T does not exceed about 10 meters, and wherein a range of the second audio signal as transmitted by the transceiver T does not exceed about 10 meters.

11. The system of claim 1, wherein the first audio signal and the second audio signal are generated by a source device electrically coupled to the transceiver T.

12. The system of claim 11, wherein the source device is a compact disc(CD) player, a cassette tape player, or a Moving Picture Experts Group Audio Layer 3 (MP3) player.

13. The system of claim 11, wherein the transceiver T is comprised by a semiconductor chip internally disposed within the source device.

14. The system of claim 11, wherein the transceiver T is disposed external to the source device and is electrically connected to the source device through a line output channel of the source device.

15. The system of claim 1, wherein the first audio signal and the second audio signal are generated by a source device electrically coupled to a Bluetooth transceiver TS through wiring, the transceiver TS adapted to wirelessly transmit the first and second audio signals over different channels to the transceiver T in accordance with prevailing Bluetooth standards, the transceiver T being a repeater transceiver for the first audio signal and the second audio signal.

16. The system of claim 15, wherein the source device is a compact disc(CD) player, a cassette tape player, or a Moving Picture Experts Group Audio Layer 3 (MP3) player.

17. The system of claim 15, wherein the transceiver T is comprised by a semiconductor chip internally disposed within the source device.

18. The system of claim 15, wherein the transceiver T is disposed external to the source device and is electrically connected to the source device through a line-out port of the source device.

19. The system of claim 15, wherein the first audio signal is adapted to be transmitted by the transceiver TS to the transceiver T at a power not exceeding about 1 milliwatt, and wherein the second audio signal is adapted to be transmitted by the transceiver TS to the transceiver T at a power not exceeding about 1 milliwatt.

20. The system of claim 15, wherein a range of the first audio signal as transmitted by the transceiver TS does not exceed about 10 meters, and wherein a range of the second audio signal as transmitted by the transceiver TS does not exceed about 10 meters.

21. A method for signal communication, comprising:
wirelessly receiving, by a first Bluetooth transceiver T1, a first audio signal transmitted by a Bluetooth transceiver T over a first channel, the fist audio signal being transmitted by the transceiver T and received by the transceiver T1 in accordance with prevailing Bluetooth standards, the transceiver T being comprised by a first earpiece fitted within or behind a first ear of a person in a manner that is sufficient for the person to hear the first audio signal; and
wirelessly receiving, by a second Bluetooth transceiver T2, a second audio signal transmitted by the transceiver T over a second channel, the second audio signal being transmitted by the transceiver T and received by the transceiver T2 in accordance with prevailing Bluetooth standards, the Bluetooth transceiver T being comprised by a second earpiece fitted within or behind a second ear of the person in a manner that is sufficient for the person to hear the second audio signal, the combination of the first audio signal and the second audio signal being a stereo signal, the first earpiece and the second earpiece not being mechanically connected to each other by a headset or by any mechanical device that is adapted to fit on the head of the person.

22. The method of claim 21, wherein the first earpiece and the second earpiece are not mechanically connected to each other by any mechanical device.

23. The method of claim 21, wherein the first earpiece and the second earpiece are each adapted fitted within the concha bowl of the first ear and the second ear, respectively.

24. The method of claim 21, wherein the first earpiece and the second earpiece are each fitted in the canal, but not wholly within the concha bowl, of the first ear and the second ear, respectively, and wherein the first and second earpieces are primarily visible to an ordinary observer of the first ear and the second ear.

25. The method of claim 21, wherein the first earpiece and the second earpiece are fitted in the canal of the first ear and the second ear, respectively, and wherein the first and second earpieces are primarily not visible to an ordinary observer of the first ear and the second ear.

26. The method of claim 21, wherein the first earpiece and the second earpiece are each fitted behind the first ear and the second ear, respectively.

27. The method of claim 21, wherein the first and second earpieces are not adapted to facilitate transmission of voice vibrations of the person to the transceiver T.

28. The method of claim 21, wherein the first audio signal and the second audio signal are a first stereo component and a second stereo component, respectively, of a musical signal.

29. The method of claim 21, wherein the first audio signal is transmitted by the transceiver T to the transceiver T1 at a power not exceeding about 1 milliwatt, and wherein the second audio signal is transmitted by the transceiver T to the transceiver T2 at a power not exceeding about 1 milliwatt.

30. The method of claim 21, wherein a range of the first audio signal as transmitted by the transceiver T does not exceed about 10 meters, and wherein a range of the second audio signal as transmitted by the transceiver T does not exceed about 10 meters.

31. The method of claim 21, wherein a source device is electrically coupled to the transceiver T by wiring, and wherein the first audio signal and the second audio signal are generated by the source device.

32. The method of claim 31, wherein the source device is a compact disc(CD) player, a cassette tape player, or a Moving Picture Experts Group Audio Layer 3 (MP3) player.

33. The method of claim 3 1, wherein the transceiver T is comprised by a semiconductor chip internally disposed within the source device.

34. The method of claim 31, wherein the transceiver T is disposed external to the source device and is electrically connected to the source device through a line output channel of the source device.

35. The method of claim 21, wherein the first audio signal and the second audio signal are generated by a source device electrically coupled to a Bluetooth transceiver TS through wiring, and wherein the first and second audio signals are wirelessly transmitted by the transceiver TS over different channels to the transceiver T in accordance with prevailing Bluetooth standards, the transceiver T being a repeater transceiver for the first audio signal and the second audio signal.

36. The method of claim 35, wherein the source device is a compact disc(CD) player, a cassette tape player, or a Moving Picture Experts Group Audio Layer 3 (MP3) player.

37. The method of claim 35, wherein the transceiver T is comprised by a semiconductor chip internally disposed within the source device.

38. The method of claim 35, wherein the transceiver T is disposed external to the source device and is electrically connected to the source device through a line-out port of the source device.

39. The method of claim 35, wherein the first audio signal is transmitted by the transceiver TS at a power not exceeding about 1 milliwatt, and wherein the second audio signal is transmitted by the transceiver TS at a power not exceeding about 1 milliwatt.

40. The method of claim 35, wherein a range of the first audio signal as transmitted by the transceiver TS to the transceiver T does not exceed about 10 meters, and wherein a range of the second audio signal as transmitted by the transceiver TS to the transceiver T does not exceed about 10 meters.
